(19) United States
(12) Patent Application Publication
(10) Pub. No.: US 2009/0019195 A1
(43) Pub. Date: Jan. 15, 2009

(54) INTEGRATED CIRCUIT, MEMORY MODULE AND SYSTEM

(76) Inventor: SRDJAN DJORDJEVIC, Munich (DE)

Correspondence Address: PATTERSON & SHERIDAN, LLP;Gero McClellan / Qimonda, 3040 POST OAK BLVD.,, SUITE 1500, HOUSTON, TX, 77056, US

(21) Appl. No.: 11/777,867

(22) Filed: Jul. 13, 2007

(51) Int. Cl. G06F 5/00

(52) U.S. Cl. 710/53

(57) ABSTRACT

An integrated circuit comprises a first data interface configured to be coupled to a first memory device, a second data interface configured to be coupled to a second memory device, a first control interface configured to be coupled to the first memory device, and a second control interface configured to be coupled to the second memory device. The control interfaces are arranged between the first data interface and the second data interface or the data interfaces are arranged between the first control interface and the second control interface.

### BACKGROUND OF THE INVENTION

### Field of the Invention

The invention generally relates to integrated circuits, memory modules and systems containing the same.

### SUMMARY OF THE INVENTION

Embodiments of the invention generally provide integrated circuits, memory modules and systems containing the same.

One embodiment provides an integrated circuit including a first data interface configured to be coupled to a first memory device, a second data interface configured to be coupled to a second memory device, a first control interface configured to be coupled to the first memory device, and a second control interface configured to be coupled to the second memory device. The control interfaces are arranged between the first data interface and the second data interface or the data interfaces are arranged between the first control interface and the second control interface.

### BRIEF DESCRIPTION OF THE DRAWINGS

The features of embodiments will become clear from the following description, taken in conjunction with the accompanying drawings. It is to be noted, however, that the accompanying drawings illustrate only typical embodiments and are, therefore, not to be considered limiting of the scope of the invention. It may admit other equally effective embodiments.

FIG. 1 shows a schematic representation of an integrated circuit according to an embodiment;

FIG. 2 shows a schematic representation of an integrated circuit according to another embodiment;

FIG. 3 shows a schematic representation of a memory module according to an embodiment;

FIG. 4 shows a schematic representation of a memory module according to another embodiment;

FIG. 5 shows a schematic representation of a memory module according to another embodiment;

FIG. 6 shows a schematic representation of a memory module according to another embodiment;

FIG. 7 shows a schematic representation of a system according to an embodiment;

FIG. 8 shows a schematic representation of a system according to another embodiment;

FIG. 9 shows a schematic representation of a system according to another embodiment; and

FIG. 10 shows a schematic representation of a system according to another embodiment.

### DETAILED DESCRIPTION OF THE PREFERRED EMBODIMENT

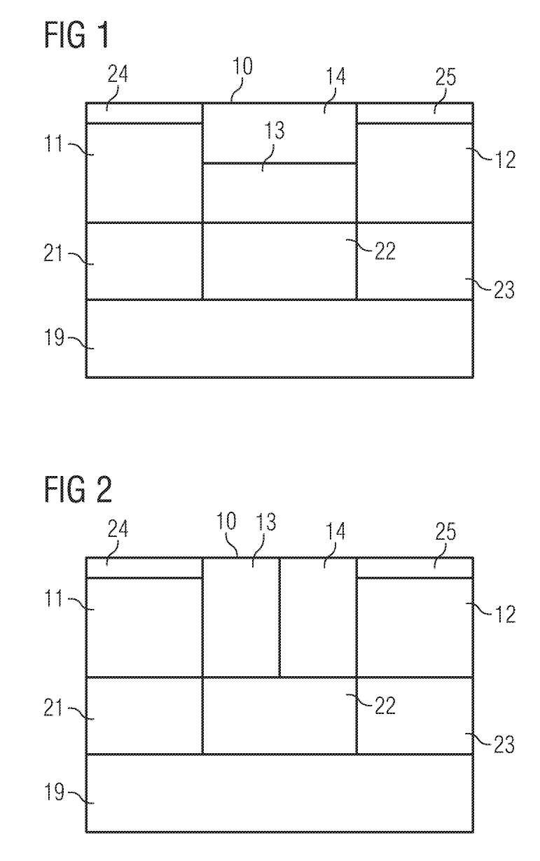

FIGS. 1 and 2 display schematic representations of integrated circuits 10. Each of the integrated circuits 10 schematically represented in FIGS. 1 and 2 can be a memory buffer circuit, for example an advanced memory buffer (AMB) for a fully buffered (FB) dual inline memory module (DIMM) or any other memory module. Each of the integrated circuits 10 described below with reference to FIGS. 1 and 2 can, as an alternative, be a memory controller, for example a memory controller providing functionalities of a memory buffer. Each of the integrated circuits 10 can, as a further exemplary alternative, be a processor.

Each of FIGS. 1 and 2 schematically represents the spatial distribution of interfaces at a surface of the respective integrated circuit 10. For example, each of the integrated circuits 10 described below is a package comprising a semiconductor die, and the interfaces comprise a ball grid array (BGA) or a fine ball grid array (FBGA) or any other solder or solder-free electrical contacts provided for a connection to a printed circuit board. Each of the integrated circuits 10 described below with reference to FIGS. 1 and 2 can, as a further exemplary alternative, be a bare semiconductor die, wherein the interfaces displayed in FIGS. 1 and 2 comprise bond pads or other electrical contacts on a surface of the die. Optical interfaces for transmitting and receiving optical signals can be provided instead of electrical contacts.

In any case, the floor plan of the integrated circuit, in particular the spatial distribution of components and sub-circuits, can be similar to the geometrical layout of the interfaces described below with reference to FIGS. 1 and 2. From a similarity of the floor plan and the spatial distribution of interfaces, short signal paths, low loss, short propagation times and high signal integrity (SI) can result under certain conditions.

Each of the integrated circuits 10 schematically represented in FIGS. 1 and 2 comprises a first data interface 11, a second data interface 12, a first control interface 13, a second control interface 14, a controller interface 19 and several sections 21, 22, 23, 24, 25 of a supply voltage interface. Not all of these interfaces are necessary for all applications of the integrated circuits 10.

The first data interface 11 and the first control interface 13 are configured to be coupled to a first memory device. The second data interface 12 and the second control interface 14 are configured to be coupled to a second memory device. Each of the first and second memory devices can be one of a DRAM, an SRAM, an FRAM, an MRAM, a PCRAM, a CBRAM or any other volatile or non-volatile memory device. Each of the data interfaces 11, 12 and each of the control interfaces 13, 14 can be configured to be coupled to a respective group of memory devices. Each of the control interfaces 13, 14 can comprise command, address, control, clock and other signal lines.

The controller interface 19 is configured to be coupled to a memory controller or a processor including memory controller functionality or any other circuitry providing memory controller functionality. The controller interface 19 is, for example, a high-speed interface comprising an input and an output for southbound communication and an input and an output for northbound communication according to an industry standard defining fully buffered dual inline memory modules (FB-DIMMs).

The supply voltage interface is configured to be coupled to a voltage supply supplying one or several voltages and electrical power to the integrated circuits 10. For example, a supply voltage V_{CC} is supplied to the second section 22 of the supply voltage interface and a voltage V_{DD} is supplied to the other sections 21, 23, 24, 25 of the supply voltage interface.

In both integrated circuits schematically represented in FIGS. 1 and 2, each of the first and second data interfaces 11, 12 and each of the first and second control interfaces 13, 14 occupy a respective region with a convex or at least non-concave contour. In the particular embodiments displayed in FIGS. 1 and 2, each of the first and second data interfaces 11, 12 and each of the first and the second control interfaces 13, 14 occupy an essentially rectangular respective region. The first and second data interfaces 11, 12 and the first and second control interface 13, 14 can be arranged in an essentially contiguous interface region, as it is shown in FIGS. 1 and 2. In the embodiments schematically represented in FIGS. 1 and 2, large parts (in particular the first, second and third sections 21, 22, 23) of the supply voltage interface are arranged between the controller interface 19 and the first and second data and control interfaces 11, 12, 13, 14.

Referring to FIG. 1, a borderline between the first and second control interfaces 13, 14 essentially extends from the first data interface 11 to the second data interface 12. When a first direction is defined by the direction from the first data interface 11 to the second data interface 12, for example from the center of mass of the first data interface 11 to the center of mass of the second data interface 12, and a second direction is defined by the direction from the first control interface 13 to the second control interface 14, for example from the center of mass of the first control interface 13 to the center of mass of the second control interface 14, these first and second directions are essentially perpendicular to each other.

Referring to FIG. 2, the first control interface 13 is arranged between the first data interface 11 and the second control interface 14, and the second control interface 14 is arranged between the first control interface 13 and the second data interface 12. When a first and second direction are defined as they are defined above with reference to FIG. 1, the first and second directions are essentially parallel to each other. In the embodiment schematically represented in FIG. 2, the borderline between the first data interface 11 and the first control interface 13, a borderline between the first control interface 13 and the second control interface 14, and a borderline between the second control interface 14 and the second data interface 12 are essentially parallel to each other.

In both embodiments described above with reference to FIGS. 1 and 2, the first and second data interfaces 11, 12 and the first and second control interfaces 13, 14 can, as an alternative, be interchanged. In this case, the first and second data interfaces are arranged between the first and second control interfaces, for example in one of the geometries described above with reference to FIGS. 1 and 2.

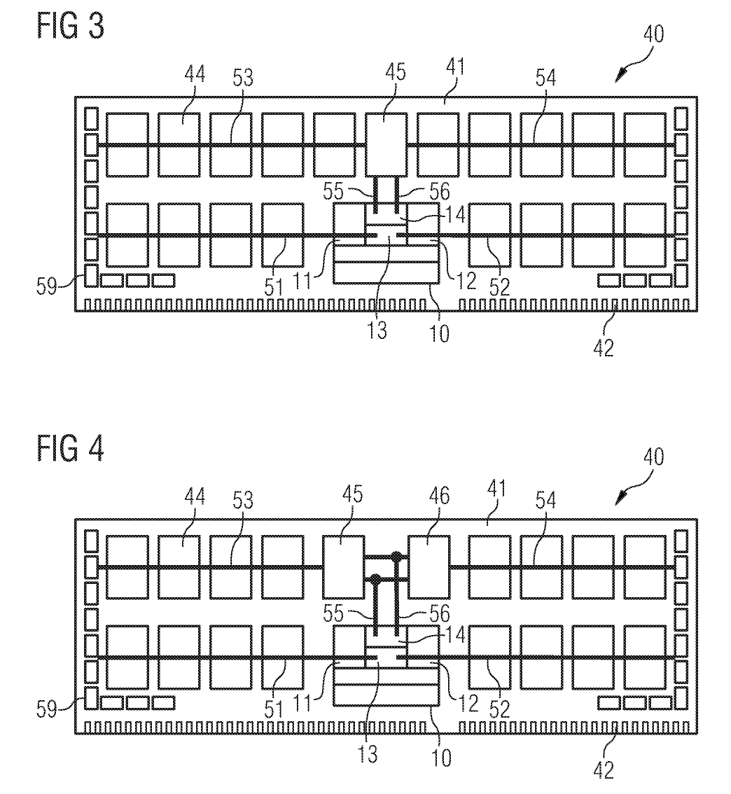

As already mentioned above, each of the integrated circuits described above with reference to FIGS. 1 and 2 can be a memory buffer. FIGS. 3 to 6 schematically represent memory modules 40. Each of the memory modules 40 described below with reference to FIGS. 3 to 6 comprises an integrated circuit 10 as described above as a memory buffer or an advanced memory buffer. Each of the memory modules 40 further comprises a printed circuit board 41, electrical contacts 42 (or an equivalent optical interface) and at least one edge of the printed circuit board 41. Furthermore, each of the memory modules comprises a number of memory devices 44, for example DRAM, SRAM, FRAM, MRAM, CBRAM, PCRAM or other volatile or non-volatile memory devices.

Although, in each of FIGS. 3 to 6, only one side (the front side) of the respective memory module 40 is displayed, electrical contacts 42 and memory devices 44 can be arranged at the second side (the rear side) of the printed circuit board 41 as well. One integrated circuit 10 is provided for each memory module 40 and arranged at the front sides displayed in FIGS. 3 to 6. As an alternative, a second integrated circuit 10 can be provided at the rear side of the printed circuit board 41 in each of the embodiments described below with reference to FIGS. 3 to 6.

In FIGS. 3 to 6, coupling lines from the data interfaces 11, 12 of the integrated circuits 10 to the memory devices 44 are not displayed. Although the memory devices 44 can be arranged at one or both sides of the printed circuit boards 41 in different ways, in all the embodiments described below with reference to FIGS. 3 to 6, the memory devices 44 are arranged in two rows. A first row of memory devices 44 is arranged next to the electrical contacts 42, and a second row of memory devices 44 is arranged more distant from the electrical contacts 42.

Referring to FIG. 3, the memory devices 44 of the first row are coupled to the first control interface 13 of the integrated circuit 10 via first and second coupling lines 51, 52. The memory devices 44 in the second row are coupled to a register 45 via third and fourth coupling lines 53, 54. The register 45 is coupled to the second control interface 14 of the integrated circuit 10 via fifth and sixth coupling lines 55, 56. Each of the reference numerals 51, 52, 53, 54, 55 and 56 refers to a plurality of coupling lines coupling corresponding pairs of outputs of the respective control interface 13, 14 and inputs of the respective memory devices 44.

Some of the coupling lines 51, . . . , 56 form point-to-point connections between an input/output of the respective control interface 13, 14 and an input/output of one of the memory devices 44 (similar to DQS, /DQS). Some of the coupling lines 51, . . . , 56 are bus-like and connect a respective input/output of one of the control interfaces 13, 14 to the respective inputs/outputs of a group of memory devices 44 or of all memory devices 44 of the respective row (for example ODT, BA0, BA1, BA2, A0 through A15, RAS, CAS, /WE, CK, /CK). The bus-like coupling lines 51, . . . , 54 can be terminated with termination resistors 59. The termination resistors 59 are arranged in a peripheral region of the printed circuit board 41.

The register 45 can serve one or several of a broad variety of purposes. In particular, the register 45 can reduce the load of the second control interface 14, improve the signal quality, serve as a multiplexer, provide a predetermined timing of the signals etc. For this purpose, the register 45 can be a ½ register, for example. The shortness of the fifth and sixth coupling lines 55, 56 can facilitate good signal integrity of the command, address and control signals provided from the integrated circuit 10 to the register 45.

When memory devices 44 are additionally provided at the rear side of the printed circuit board 41, the rear side memory devices can be coupled to the integrated circuit 10 and the register 45 via the same coupling lines 51, 52, 53, 54. In particular, memory devices in a first row (next to the contacts 42) at the rear side of the printed circuit board 41 and the memory devices 44 in the first row at the front side (displayed in FIG. 3) of the printed circuit board 41 can be coupled to the first control interface 13 of the integrated circuit 10 via the first and second coupling lines 51, 52, and memory devices arranged in a second row (distant from the contacts 42) at the rear side of the printed circuit board 41 and the memory devices 44 in the second row at the front side of the printed circuit board 41 can be coupled to the register 45 via the third and fourth coupling lines 53, 54.

For example, four memory devices 44 at the front side of the printed circuit board 41 and five memory devices at the rear side of the printed circuit board 41 are coupled to the first control interface 13 via the first coupling lines 51; four memory devices 44 at the front side of the printed circuit board 41 and five memory devices at the rear side of the printed circuit board 41 are coupled to the first control interface 13 via the second coupling lines 52; five memory devices 44 at the front side of the printed circuit board 41 and four memory devices at the rear side of the printed circuit board 41 are coupled to the register 45 via the third coupling lines 53; and five memory devices 44 at the front side of the printed circuit board 41 and four memory devices at the rear side of the printed circuit board 41 are coupled to the register 45 via the fourth coupling lines 54.

Each of the memory devices 44 can comprise one (single die package), two (dual die package) or even more dies within one package. The register 45 and the fifth and sixth coupling lines 55, 56 can be omitted when the third and fourth coupling lines 53, 54 are directly coupled to the second control interface 14 of the integrated circuit 10. The coupling lines 51, . . . , 56 can comprise electrically conductive lines and/or optical fibers, waveguides or other coupling facilities transferring electrical, optical or other signals between the integrated circuit 10, the register 45 and the memory devices 44.

FIG. 4 displays a schematic representation of a memory module 40 according to another embodiment. The embodiment displayed in FIG. 4 differs from the embodiment described above with reference to FIG. 3 in that two registers 45, 46 are provided instead of one. For this purpose, the fifth and sixth coupling lines 55, 56 comprise point-to-two-point (P22P) connections between the second control interface 14 and the first and second registers 45, 46. Again, memory devices 44 can be arranged at the front side of the printed circuit board 41 or at both the front side and the rear side of the printed circuit board 41; each memory device 44 can comprise one, two or more dies in a single package, the coupling lines 51, . . . , 56 can comprise of electrical, optical or other coupling facilities. Further alternatives and variants described above with reference to FIG. 3 are valid for the embodiment schematically represented in FIG. 4 as well.

For example, four memory devices 44 arranged at the front side of the printed circuit board 41 and five memory devices arranged at the rear side of the printed circuit board 41 are coupled to the first register 45 via the third coupling lines 53, and four memory devices 44 arranged at the front side of the printed circuit board 41 and five memory devices arranged at the rear side of the printed circuit board 41 are coupled to the second register 46 via the fourth coupling lines 45.

At each of the memory modules 40 described above with reference to FIGS. 3 and 4, the first and second control interfaces 13, 14 of the integrated circuit 10 are arranged as described above with reference to FIG. 1. This can, under certain conditions, facilitate particularly short and straight coupling lines 51, . . . , 56 with a low number of crossings. However, the arrangement of the first and second control interfaces 13, 14 described above with reference to FIG. 2 can be used as well. As a further alternative, the above described variant with data interfaces arranged between the control interfaces can be used as well.

As already mentioned above, coupling lines between the data interfaces 11, 12 and the memory devices 44 are not displayed in FIGS. 3 to 6. According to one option, the memory devices 44 coupled to the first control interface 13 are coupled to the first data interface 11, and the memory devices 44 coupled to the second control interface 14 are coupled to the second data interface 12. As a consequence, the first data interface 11 is coupled to memory devices 44 in the first row, both to the left and to the right of the integrated circuit 10, wherein “left” and “right” refer to the schematic representation displayed in FIGS. 3 and 4; and the second data interface 12 is coupled to memory devices 44 in the second row, both to the left and to the right of the integrated circuit 10.

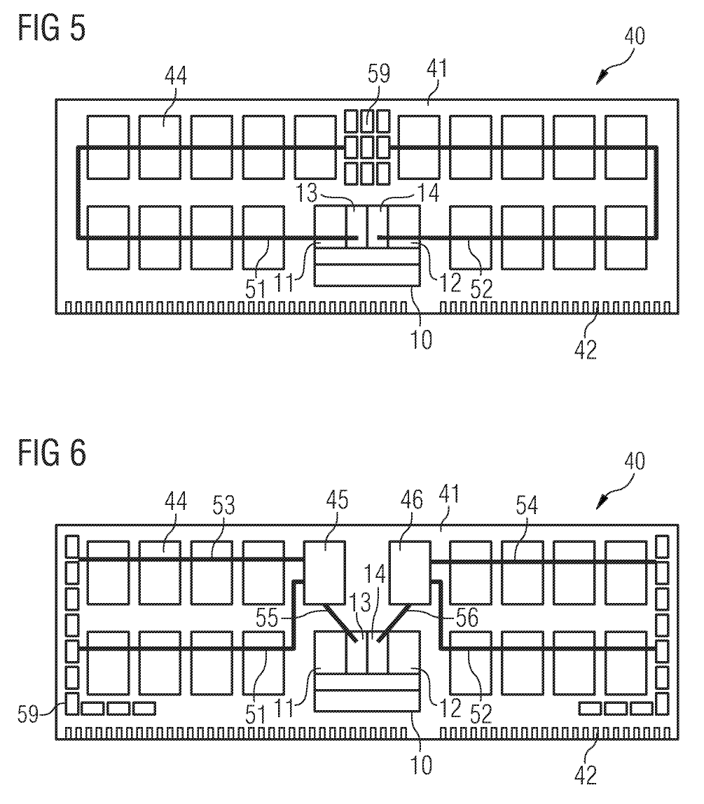

FIG. 5 displays a schematic representation of a memory module 40 according to another embodiment. The embodiment shown in FIG. 5 differs from the embodiments and variants described above with reference to FIGS. 3 and 4 in that no register is provided, one group of memory modules 44 is coupled to the first control interface 13 via first coupling lines 51 and another group of memory modules 44 is coupled to the second control interface 14 via second coupling lines 52. Again, memory devices 44 can be provided merely on the front side of the printed circuit board 41 or at both the front side and the rear side of the printed circuit board 41. Each memory device 44 can comprise of one, two or more dies in a single package, the coupling lines 51, 52 can comprise of electrical, optical or other coupling facilities. Further alternatives and variants described above with reference to FIGS. 3 and 4 are valid for the embodiment schematically represented in FIG. 5 as well.

When the memory devices 44 are arranged in a first row (close to the contacts 42) and a second row (distant from the contacts 42), the coupling lines 51, 52 can provide the shape of a “U” with the ends and the end termination resistors 59 arranged close to the center of the printed circuit board 41 as it is displayed in FIG. 5. As an example, all the memory devices 44 are arranged at the front side of the printed circuit board 41, wherein each of the memory devices 44 comprises two dies in a single package, wherein nine memory devices 44 are coupled to the first control interface 13 via the first coupling lines 51, and wherein nine memory devices are coupled to the second control interface 14 via the second coupling lines 52. As a further example, 18 memory devices 44 are arranged at the front side of the printed circuit board 41, and 18 memory devices are arranged at the rear side of the printed circuit board 41, wherein each memory device 44 comprises a single die in a single package, wherein nine memory devices 44 at the front side and nine memory devices at the rear side of the printed circuit board 41 are coupled to the first control interface 13 via the first coupling lines 51, and wherein nine memory devices 44 at the front side and nine memory devices at the rear side of the printed circuit board 41 are coupled to the second control interface 14 via the second coupling lines 52.

FIG. 6 schematically represents a memory module 40 according to another embodiment. The memory module 40 comprises a first group of memory devices 44 coupled to a first register 45 via first coupling lines 51, a second group of memory devices 44 coupled to a second register 46 via second coupling lines 52, a third group of memory devices 44 coupled to the first register 45 via third coupling lines 53 and a fourth group of memory devices 44 coupled to the second register 46 via fourth coupling lines 54. The first register 45 is coupled to the first control interface 13 of the integrated circuit 10 via fifth coupling lines 55, and the second register 46 is coupled to the second control interface 14 of the integrated circuit 10 via sixth coupling lines 56. Similar to the embodiments described above with reference to FIGS. 3 and 4, end termination resistors 59 are arranged in a peripheral region of the printed circuit board 41.

The first and third coupling lines 51, 53 can be coupled to a single interface of the first register 45, and the second and fourth coupling lines 52, 54 can be coupled to a single interface of the second register 46. As an alternative, each of the registers 45, 46 provides two separate interfaces for the coupling lines 51, 53, 52, 54, wherein the first coupling lines 51 are coupled to a first interface of the first register 45, the third coupling lines 53 are coupled to a second interface of the first register 45, the second coupling lines 52 are coupled to a first interface of the second register 46, and the fourth coupling lines 54 are coupled to a second interface of the second register 46. Variants and alternatives described above with reference to FIGS. 3 to 5 can be applied to the embodiment schematically represented in FIG. 6 as well.

As an example, all the memory devices 44 of the memory module 40 are arranged at the front side of the printed circuit board 41, wherein four memory devices 44 are coupled to the first register 45 via the first coupling lines 51, four memory devices 44 are coupled to the first register 45 via the third coupling lines 53, four memory devices 44 are coupled to the second register 46 via the second coupling lines 52, and four memory devices 44 are coupled to the second register 46 via the fourth coupling lines 54. As another example, memory devices 44 are arranged at both the front side and the rear side of the printed circuit board 41, wherein four memory devices 44 at the front side and five memory devices at the rear side are coupled to the first register 45 via the first coupling lines 51, four memory devices 44 at the front side and five memory devices at the rear side are coupled to the first register 45 via the third coupling lines 53, four memory devices 44 at the front side and five memory devices at the rear side are coupled to the second register 46 via the second coupling lines 52, and four memory devices 44 at the front side and five memory devices at the rear side are coupled to the second register 46 via the fourth coupling lines 54.

In the embodiments described above with reference to FIGS. 5 and 6, the arrangement of the control interfaces 13, 14 described above with reference to FIG. 2 is displayed. This arrangement can, under certain conditions, facilitate short and straight coupling lines 51, 52 or 55, 56, respectively, with a low number of crossings and corners, thereby facilitating good signal integrity or other advantages. As an alternative, the arrangement of the control interfaces 13, 14 described above with reference to FIG. 1 can be applied to the embodiments described above with reference to FIGS. 5 and 6.

Regarding all the embodiments described above with reference to FIGS. 5 and 6, according to one option, the memory devices 44 coupled to the first control interface 13 are coupled to the first data interface 11, and the memory devices 44 coupled to the second control interface 14 are coupled to the second data interface 12. As a consequence, memory devices 44 to the left of the integrated circuit 10 are coupled to the first data interface 11 and memory devices 44 to the right of the integrated circuit 10 are coupled to the second data interface 12 of the integrated circuit 10, wherein “left” and “right” refer to the schematic representation displayed in FIGS. 3 and 4. This arrangement can, under certain conditions, facilitate short and straight coupling lines between the data interfaces 11, 12 of the integrated circuit 10 and the memory devices 44.

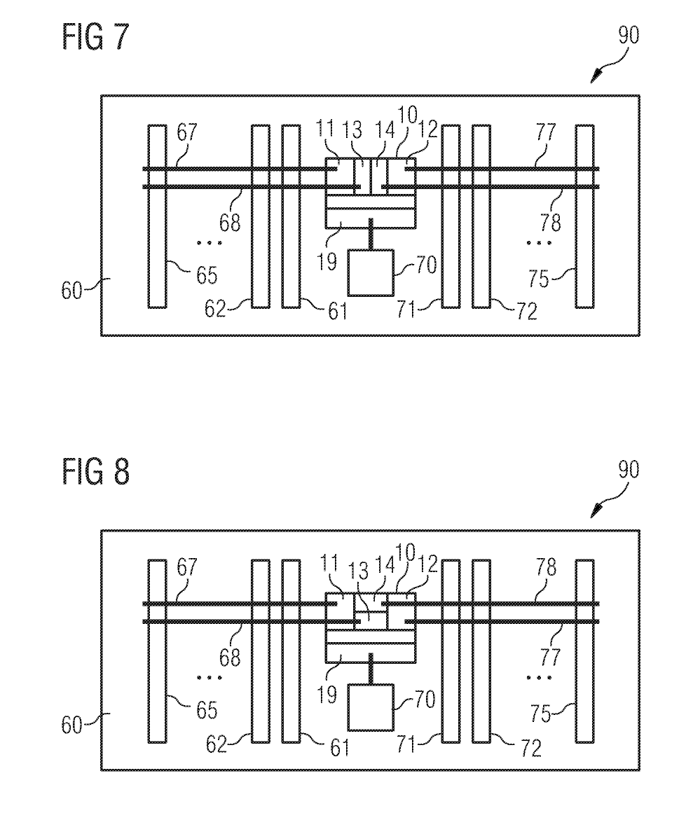

Each of FIGS. 7 to 10 displays a schematic representation of a system 90 comprising an integrated circuit 10 as described above with reference to FIG. 1 or 2, including the above-described variants and alternatives. Each of the systems 90 can, for example, be a personal computer, a laptop computer, a workstation, a server or any other computer or a part or sub-system of a computer. Each of the systems 90 comprises a printed circuit board 60, wherein the integrated circuit 10, a memory controller 70 and a number of memory module slots 61, 62, 65, 71, 72, 75 are arranged at the printed circuit board 60. Each of the memory module slots 61, 62, 65, 71, 72, 75 is provided for and configured to accommodate, or receive, a memory module.

In each of the systems 90 schematically represented in one of FIGS. 7 to 10, a first group of memory module slots 61, 62, 65 is coupled to a first data interface 11 of the integrated circuit 10 via first coupling lines 67 and to a first control interface 13 of the integrated circuit 10 via second coupling lines 68, and a second group of memory module slots 71, 72, 75 is coupled to the second data interface 12 of the integrated circuit via third coupling lines 77 and to the second control interface 14 of the integrated circuit 10 via fourth coupling lines 78. The coupling lines 67, 68, 77, 78 can comprise bus-like connections between the respective interface 11, 12, 13, 14 and several or all of the memory module slots of the respective group of memory module slots 61, 62, 65 or 71, 72, 75. As an alternative or additionally, the coupling lines 67, 68, 77, 78 can comprise of point-to-point connections between the respective interface 11, 12, 13, 14 and one of the memory module slots 61, 62, 65, 71, 72, 75 or between two of the memory module slots 61, 62, 65, 71, 72, 75.

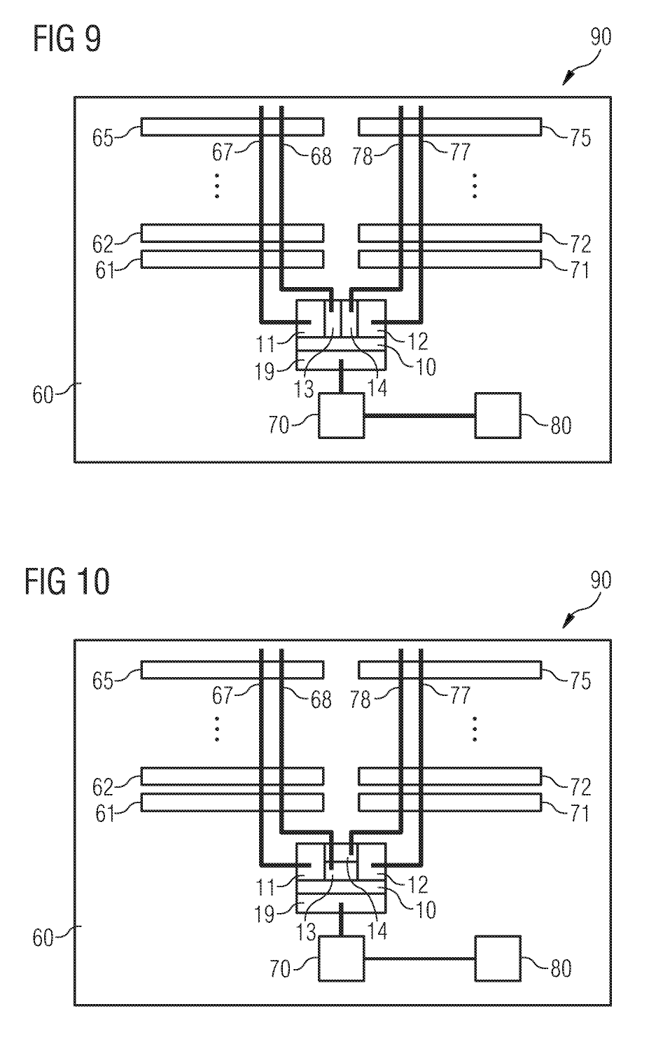

In all the embodiments described below with reference to FIGS. 7 to 10, a memory controller 70 is coupled to the controller interface 19 of the integrated circuit 10. In the embodiments described below with reference to FIGS. 9 and 10, a processor 80 is coupled to the memory controller 70. Each of the memory controller 70 and the processor 80 are optional, and each of the embodiments described below with reference to FIGS. 7 and 8 can comprise a processor 80 as well.

The embodiments described below with reference to FIGS. 7 and 8 differ from the embodiments described below with reference to FIGS. 9 and 10 in the geometry of the arrangement of the memory module slots 61, 62, 65, 71, 72, 75. While the embodiments schematically represented in FIGS. 7 and 9 provide an arrangement of the control interfaces 13, 14 of the integrated circuit 10 as described above with reference to FIG. 1, the embodiments schematically represented in FIGS. 8 and 10 provide an arrangement of the control interfaces 13, 14 of the integrated circuit 10 as described above with reference to FIG. 2.

In the embodiments schematically represented in FIGS. 7 and 8, all the memory module slots 61, 62, 65, 71, 72, 75 are arranged in one row, wherein the integrated circuit 10 is arranged at or near the center of this row. In the embodiments schematically represented by FIGS. 9 and 10, the first group of memory module slots 61, 62, 65, coupled to the first data interface 11 and the first control interface 13 of the integrated circuit 10, are arranged in a first column, and the second group of memory module slots 71, 72, 75, coupled to the second data interface 12 and the second control interface 14 of the integrated circuit 10, are arranged in a second column parallel to the first column. As can be seen from FIGS. 7 to 10, both arrangements of the data interfaces 11, 12 and the control interfaces 13, 14 can, under certain conditions, facilitate short and straight coupling lines 67, 68, 77, 78 with a low number of crossings.

Each of the integrated circuits 10 described above with reference to FIGS. 1 and 2 can be configured and optimized for one or several of the embodiments described above with reference to FIGS. 3 to 10. In particular, the integrated circuits 10 can be optimized for an application as a memory buffer or an advanced memory buffer in a FB DIMM (similar to the embodiments of FIGS. 3 to 6) or for an application as an on board memory buffer (BoB; similar to the embodiments of FIGS. 7 to 10). However, the integrated circuit can be configured to be used in both FB DIMM and BoB applications as well.

The preceding description describes advantageous exemplary embodiments. The features disclosed therein and the claims and the drawings can, therefore, be useful for realizing various embodiments, both individually and in any combination. While the foregoing is directed to specific embodiments, other and further embodiments may be devised without departing from the basic scope, the scope being determined by the claims that follow.

What is claimed is:

1. An integrated circuit, comprising:
a first data interface configured to be coupled to a first memory device;
a second data interface configured to be coupled to a second memory device;
a first control interface configured to be coupled to the first memory device; and
a second control interface configured to be coupled to the second memory device;
wherein the control interfaces are arranged between the first data interface and the second data interface or the data interfaces are arranged between the first control interface and the second control interface.

2. The integrated circuit as claimed in claim 1, further comprising:
a supply voltage interface configured to receive at least one supply voltage; and
a controller interface configured to be coupled to a memory controller.

3. The integrated circuit as claimed in claim 2,
wherein the first data interface, the at least one control interface and the second data interface are arranged in a contiguous interface region, and
wherein the supply voltage interface is arranged between the interface region and the controller interface.

4. The integrated circuit as claimed in claim 1, wherein a region occupied by at least one of the first and second data interface and the first and second control interface is a rectangle or provides any other non-concave contour.

5. The integrated circuit as claimed in claim 1, wherein the first control interface is arranged between the first data interface and the second control interface, and wherein the second control interface is arranged between the first control interface and the second data interface.

6. The integrated circuit as claimed in claim 1, wherein a direction from the first control interface to the second control interface is perpendicular to the direction from the first data interface to the second data interface.

7. The integrated circuit as claimed in claim 1, wherein the integrated circuit is a semiconductor die with an integrated circuit, and wherein at least one of the data and control interfaces comprises electrical contacts at a surface of the die.

8. The integrated circuit as claimed in claim 1, wherein the integrated circuit comprises an integrated circuit in a package, and wherein at least one of the data and control interfaces comprises electrical contacts at a surface of the package.

9. The integrated circuit as claimed in claim 1, wherein the integrated circuit is a memory buffer.

10. An apparatus, comprising:
a memory module; and
an integrated circuit formed on the memory module, the integrated circuit comprising:
a first data interface configured to be coupled to a first memory device;
a second data interface configured to be coupled to a second memory device;
a first control interface configured to be coupled to the first memory device; and
a second control interface configured to be coupled to the second memory device; and
wherein the control interfaces are arranged between the first data interface and the second data interface or the data interfaces are arranged between the first control interface and the second control interface.

11. The apparatus as claimed in claim 10, wherein the memory module further comprises:
a first group of memory devices coupled to the first data interface and to the first control interface; and
a second group of memory devices coupled to the second data interface and to the second control interface.

12. The apparatus as claimed in claim 11, wherein the first group of memory devices is coupled to a memory buffer via a first bus, and wherein the second group of memory modules is coupled to the memory buffer via a second bus.

13. The apparatus as claimed in claim 10, further comprising a register coupled between the first control interface and a first group of memory devices.

14. A system, comprising:
a processor; and
an integrated circuit communicatively connected to the processor, the integrated circuit comprising:
a first data interface configured to be coupled to a first memory device;
a second data interface configured to be coupled to a second memory device;
a first control interface configured to be coupled to the first memory device; and
a second control interface configured to be coupled to the second memory device; wherein the control interfaces are arranged between the first data interface and the second data interface or the data interfaces are arranged between the first control interface and the second control interface.

15. The system as claimed in claim 14, further comprising:
a first memory device coupled to the first data interface and to the first control interface of the integrated circuit;
a second memory device coupled to the second data interface and to the second control interface of the integrated circuit,
wherein the integrated circuit is a memory buffer.

16. The system as claimed in claim 15, wherein the integrated circuit and the first and second memory devices are arranged at a memory module comprised in the system.

17. The system as claimed in claim 14, the system further comprising:
a memory controller coupled to a controller interface of the integrated circuit.

18. The system as claimed in claim 14, wherein the processor and the integrated circuit are disposed on a printed circuit board, the printed circuit board being a main board for a computer, and wherein the processor is coupled to a controller interface of the integrated circuit.

19. The system as claimed in claim 14, further comprising:
a printed circuit board;
a first memory module slot at the printed circuit board, the first memory module slot being coupled to the first data interface and to the first control interface of the integrated circuit; and
a second memory module slot at the printed circuit board, the second memory module slot being coupled to the second data interface and to the second control interface of the integrated circuit.

20. The system as claimed in claim 19, the system further comprising:
a memory controller coupled to a controller interface of the integrated circuit.
